(19) United States
(12) Patent Application Publication
(10) Pub. No.: US 2024/0401995 A1
(43) Pub. Date: Dec. 5, 2024

(54) FIELD DEVICE FOR DETECTING A PROCESS PARAMETER

(71) Applicant: VEGA Grieshaber KG, Wolfach (DE)

(72) Inventors: Benjamin SCHAETZLE, Schuttertal (DE); René HERRMANN, Oberwolfach (DE)

(73) Assignee: VEGA Grieshaber KG, Wolfach (DE)

(21) Appl. No.: 18/733,397

(22) Filed: Jun. 4, 2024

(30) Foreign Application Priority Data
Jun. 5, 2023 (DE) 10 2023 114 724.2

(51) Int. Cl. G01F 23/80

(52) U.S. Cl. CPC G01F 23/804

(57) ABSTRACT

A field device for detecting a process parameter and being configured as a level measuring device for detecting a level of a medium is provided, the field device including: a sensor arrangement configured to detect a measurement signal correlating with a process parameter; and a computing arrangement configured to determine a measured value of the process parameter based on the measurement signal, the computing arrangement having a deterministic computer and an artificial intelligence (AI) computer based on AI, the field device being further configured to train the AI computer during operation of the AI computer. A method for training an AI computing module based on AI on a field device for detecting a process parameter is also provided. A method for operating a field device for detecting a process parameter is also provided.

### CROSS-REFERENCE TO RELATED APPLICATIONS

This application claims the benefit of priority under 35 U.S.C. § 119 from German Patent Application No. 10 2023 114 724.2 filed on 5 Jun. 2023, the entire content of which is incorporated herein by reference.

### TECHNICAL FIELD

The present disclosure relates generally to the field of process automation. In particular, the present disclosure relates to a field device for detecting a process parameter, for example a level measuring device, in particular a point level measuring device, for detecting a level of a medium. The present disclosure also relates to a method for training an artificial intelligence (AI)-based AI computing module of a field device, a method for operating a field device, a computer program product associated with the methods and training data for training an AI computing module.

### BACKGROUND

In industrial measurement technology, particularly in the field of process automation and process control, field devices are regularly used to detect one or more process parameters or process measurement parameters. Field devices include, in particular, flow rate, flow velocity, pressure, differential pressure, temperature, and level measuring devices. By means of a corresponding sensor or a corresponding sensor arrangement, the field devices generally detect a measurement signal that correlates with one or more process parameters. A computing unit, a control unit, and/or an evaluation unit of the respective field device can then be used to determine a measured value for the respective process parameter based on the measurement signal and/or based on an evaluation of the measurement signal.

In order to perform arithmetic operations during the operation of a field device, for example, arithmetic operations during the actual determination of measured values or arithmetic operations during a diagnostic procedure, field devices have been proposed that perform these arithmetic operations using artificial intelligence. The artificial intelligence is trained in advance or on the basis of a large number of field devices. Such artificial intelligence in a field device is not or hardly flexible in relation to the specific use of the field device.

### SUMMARY

With the present invention, an improved field device for detecting a process parameter can be provided in an advantageous manner, in particular for various specific applications of the field device.

The present disclosure is defined in the independent patent claims. Advantageous further developments and/or embodiments are given in the dependent patent claims and the following description.

A first aspect of the present disclosure relates to a field device for detecting a process parameter. In particular, the field device may be configured as a level measuring device for detecting the level of a medium. The field device has a sensor arrangement which is configured to detect a measurement signal correlating with a process parameter. The field device also has a calculation arrangement which is configured to detect a measured value of the process parameter based on the measurement signal. The computing arrangement has a deterministic computing module and an AI computing module based on artificial intelligence. The field device is configured to train the AI calculation module during its operation.

Advantageously, this provides a field device that enables the AI computing module to be trained during the operating time or, in other words, the runtime of the field device. Operation means the measurement mode of the field device for detecting (recording) the process parameter. As a result, the AI computing module is trained in particular on the basis of the specific application or a parameterization of the field device during operation in the specific application. Accordingly, the AI calculation module is robust against changing parameterization, which can be caused, for example, by ageing or changed applications. Unlike a previously trained field device, it may therefore be ensured that the AI computing module of the field device delivers reliable results for the specific application.

In this context, specific use is understood to mean in particular the respective use of the field device for a specific application and/or environment. For example, field devices can be used for different applications and be exposed to different environments. In order to determine precise measurement values, the field devices, in particular the sensor arrangements, can be parameterized for the different applications and/or environments in order to allow a high degree of measurement precision. The parameterization can be understood in particular as a characterization of the field device by parameters that influence the acquisition of the process parameter. The parameterization can at least include parameters of the field device itself, i.e., in particular settings of the field device, for example a measurement sensitivity. Alternatively or additionally, the parameterization can also include external parameters, such as measurement conditions, for example density of the medium to be measured, volume of a container in which the medium is contained, etc., as well as or alternatively environmental parameters, such as ambient temperature, ambient pressure, etc.

The terms computing arrangement and computing module are to be interpreted broadly. In particular, a computing arrangement may refer to a computer environment comprising at least one arithmetic unit for performing an arithmetic operation. Such a computer environment or arithmetic unit may comprise a processor for performing arithmetic operations. The computing arrangement or computer environment may optionally comprise further components such as one or more data memories. The computing module, in turn, may denote a computer program product as such or a combination of a computer program product with a computing device for executing the computer program product. By executing the computing module, a computing operation can be performed in particular, which comprises one or more computing operations.

The deterministic calculation module can be configured to perform at least one deterministic arithmetic operation. The at least one deterministic arithmetic operation of the deterministic arithmetic module can be used to determine at least the measured value of the process parameter based on the measurement signal. The term “deterministic” can mean here and in the following that the first computing module has a deterministic algorithm and/or is designed to execute such an algorithm, in which well-defined and/or reproducible states occur and/or in which a specific input always leads to the same output while passing through the same states.

The AI computing module can in turn be configured to perform at least one AI-based computing operation, in particular to perform at least one non-deterministic, probability-based and/or classification-based computing operation. A non-deterministic, probability-based and/or classification-based arithmetic operation can, for example, denote an arithmetic operation whose result can be an output of one or more probabilities or probability values for one or more classes of events and/or results. Alternatively or additionally, the output may be one or more classes and/or class labels. The AI calculation module may thus have a classifier and/or be configured as a classifier. Moreover, the AI computing module may comprise one or more artificial neural networks. The at least one AI-based arithmetic operation may thus differ from the at least one deterministic arithmetic operation.

Training data of the AI computing module may be based at least on measurement signals from the sensor arrangement. This means in particular that the AI computing module, which requires training data for training during operation of the field device, receives this at least in the form of or on the basis of the measurement signals from the sensor arrangement. The measurement signals are recorded, i.e., determined by the sensor arrangement and processed or provided unprocessed for the computing arrangement so that it can use them to determine measured values that characterize or specify the process parameter, for example a fill level of a container in a field device in the form of a level meter. The training data can comprise or be based on these processed or unprocessed measurement signals. In particular, the measurement signals can be processed in order to obtain the training data. In addition to collecting, the processing can also include cleaning, transforming and/or formatting the measurement signals. In particular, the training data can be configured for training the AI computing module of the field device. In particular, the configuration of the training data can include a condition of the training data so that it can be used to train the AI computing module. This nature can be specified by collecting the training data during operation of the field device. It is also possible to change the nature of the collected training data in order to make it usable for training. The nature can, for example, be predetermined by formatting and/or type or kind of training data. It can be advantageous to specify a certain nature of the training data, for example a certain format, such as data format or formatting of the content of the training data as such, in order to optimize the training of the AI computing module.

The field device can be configured to run a training mode in parallel to a deterministic calculation mode using the deterministic calculation module. Training data can be collected during this training mode. The AI computing module can also be trained with the training data during the training mode. Advantageously, the field device can therefore already be used before the AI computing module is trained. In the meantime, while the training mode is running, the measured values of the process parameter can be determined by the deterministic calculation module of the calculation arrangement. Consequently, the measurement signals can not only be recorded to generate training data, but the deterministic arithmetic operations of the deterministic arithmetic module can also be used to record the process parameter. Furthermore, the measured values determined by the deterministic calculation module can be used for the training data. In other words, the training data can be based at least on the measured values of the computing arrangement, in particular of the deterministic computing module (in addition to or as an alternative to the measurement signals of the sensor arrangement).

The field device can also be configured in particular to execute an AI-based computing operation of the AI computing module after a switch-on criterion based on the training operation has been met. This makes it possible to end the training mode when the training is sufficiently or fully completed, which is indicated by the fulfillment of the switch-on criterion. The switch-on criterion can, for example, be at least one of a predefined match of at least one determined measured value of the process parameter from the deterministic calculation module and at least one determined measured value of the process parameter from the AI calculation module, a predefined operating time of the field device and a predefined data quantity and/or data quality of the training data. Accordingly, the switch-on criterion can indicate quantitatively and/or qualitatively when the AI computing module is ready for AI-based computing operation and can be “switched on” by the computing arrangement.

The field device can be configured so that the execution of the AI-based computing mode ends the deterministic computing mode. Consequently, computing and/or energy resources of the computing arrangement do not have to be used additionally for the deterministic computing mode, so that resource-saving operation of the field device is possible. In addition, the AI-based computing mode can be regarded as more advantageous than the deterministic computing mode of the computing arrangement once the switch-on criterion has been met. Finally, the AI calculation module can be used to record the measured process parameter and/or additional functions, such as fault detection or changing the parameterization, more reliably and/or make them possible. The termination of the deterministic computing mode can only be temporary or at least the deterministic computing mode can be resumed, for example if the AI computing module is validated or the AI computing module is trained again, as will be explained in more detail later.

The field device can also or alternatively be configured so that the deterministic calculation mode and the AI-based calculation mode are executed in parallel. This has the advantage of enabling a mutual check of the measured values determined by the respective calculation mode in order to increase the accuracy of the process parameter detection.

Accordingly, the field device can be configured to determine the measured value on the basis of a combination of the deterministic computing mode and the AI-based computing mode executed in parallel. For example, an average value of the measured values determined in each case can be used as the measured value determined by the field device and, if applicable, output, in particular displayed. Alternatively, for example, one of the two measured values can be selected by the deterministic calculation module and the AI calculation module for determination and possibly output by the field device based on a check of the two measured values, in particular with a history of the measurement signals and/or measured values and/or by means of the AI calculation module.

Furthermore, the field device can be configured so that the AI calculation module is validated at least on the basis of determined measured values of the deterministic calculation module. This allows the AI computing module to be checked against the measured values of the deterministic computing module in order to ensure that the AI computing module is sufficiently trained and/or functions reliably with new data, i.e., measurement signals. This validation can also be carried out to check whether the aforementioned switch-on criterion has been met, whereby the switch-on criterion can in particular be a predefined match between at least one determined measured value of the process parameter from the deterministic calculation module and at least one determined measured value of the process parameter from the AI calculation module. Otherwise, further optimization and further training of the AI calculation module can also take place if the validation has shown that the results of the AI calculation module with the new data do not yet meet the requirements according to the switch-on criterion.

The field device can also be configured to retrain the AI calculation module if at least one parameter that influences the acquisition of the process parameter changes. In other words, if the previously explained parameterization changes, the field device can trigger a new training of the AI calculation module. A limit value can be selected for the change in the parameter influencing the detection of the process parameter so that the AI calculation module is only retrained when this limit value is exceeded by the parameter change that has occurred. This can prevent the AI calculation module from being retrained in the event of small changes to the parameterization, for example if the parameter is an ambient temperature and this is only subject to the usual fluctuations. The retraining can be carried out in such a way that the AI computing module, in particular at least one neural network of the AI computing module, is partially or completely deleted and overwritten or supplemented with a partially or completely new AI computing module. Alternatively, the existing AI computing module can also be updated by retraining without deleting part or all of the AI computing module. For the new training, it is possible to switch to deterministic computing mode, in which deterministic computing operations of the deterministic computing module are executed.

The deterministic calculation module can be implemented in a first arithmetic unit. The AI computing module can be implemented in a second computing unit. The arithmetic units are in particular physical units in which the arithmetic modules are contained as computer program products, are stored in particular on at least one data memory of the arithmetic units and can be executed by a respective processor of the arithmetic unit. The arithmetic units can share a data memory or each have a separate data memory on which one of the arithmetic modules is stored. The arithmetic units can also share a processor at least temporarily or completely or each have their own processor in order to execute the respective arithmetic module and thereby perform the respective arithmetic operation or the respective arithmetic mode. For example, the first arithmetic unit can have a microcontroller, an x86 architecture, a Von Neumann architecture, a Harvard architecture, and/or a hybrid form of Von Neumann architecture and Harvard architecture. The second arithmetic unit can have a neuromorphic processor, a neurosynaptic processor, and/or a neuristor-based processor.

In principle, the sensor arrangement can have a sensor circuit for detecting a measurement signal that correlates with the process parameter and/or designate a sensor circuit. The sensor arrangement can have one or more sensors, for example a level sensor, a radar-based level sensor, a limit level sensor, a flow sensor, a flow velocity sensor, a temperature sensor, an acceleration sensor, and/or an actuator, for example a piezoelectric actuator, which can provide a measurement signal in the form of an input voltage, for example by absorbing voltage.

In particular, one or two measurement signals can be provided by the sensor arrangement. In the case of two measurement signals, the measurement signals can differ from each other. In particular, the measurement signals can originate from different sensors of the sensor arrangement. One of the two measurement signals can then be used for the AI calculation module described herein and the other for the deterministic calculation module described herein. The AI calculation module can then be trained with the one measurement signal and validated for the deterministic calculation module using the measurement signal, in particular by supervised learning.

In particular, the sensor arrangement can have a sensor in the form of an acceleration sensor and/or an actuator of the field device. The actuator can, for example, be a piezoelectric actuator, in particular of a vibronic point level measuring device. The actuator can, for example, provide a measurement signal in the form of an input voltage through its voltage pick-up. Such measurement signals from the acceleration sensor and actuator are correlated to the process parameter of a corresponding level measuring device, in particular a vibration level measuring device, in which the process parameter can be the reaching or non-reaching of at least one or exactly one level when a part of the sensor arrangement is covered with the medium. Such a limit level measuring device can also be referred to as a limit level switch, as a distinction can be made here between only two states in particular, namely not reaching and reaching a specified level. Such a sensor arrangement is particularly influenced by the parameterization of the field device in the specific application and therefore benefits in particular from the training of the AI computing module during the operation of the field device in the specific application area. After all, the computing arrangement has to determine whether the predefined fill level has been reached or not, so that the detection of the process variable has a decisive influence on, for example, the filling of a container with the field device contained therein.

In principle, the field device can be designed as a level measuring device of any type, in particular as a radar-based level measuring device for detecting the level of a medium, as a vibronic level measuring device, as a flow measuring device for detecting the flow rate of a medium, as a flow velocity measuring device for detecting the flow velocity of a medium, as a pressure measuring device for detecting a pressure or differential pressure and/or as a temperature measuring device for detecting a temperature. The field device can also be any other field device.

In particular, however, the field device can be designed as a vibronic point level measuring device or, in other words, a vibration point level measuring device, in particular for monitoring a point level by detecting coverage of at least part of the sensor arrangement by a medium.

Depending on the filling level in a measuring container, such a point level measuring device is in contact with a medium or not, so that an oscillation frequency/damping or oscillation amplitude of a diaphragm or a mechanical oscillator of the point level measuring device arranged on the diaphragm is influenced by the contact with the medium. Such a vibronic point level measuring device, which detects a medium by detuning an oscillating system of the point level measuring device, can have at least one piezoelectric system for exciting and/or evaluating the oscillating system. When interacting with the medium, an oscillating element of the oscillating system, for example a tuning fork, can be detuned by interacting with the medium in order to detect the medium. Alternatively, at least one electromagnetic system can be used to excite and evaluate the oscillating system. Such a level measuring device is particularly influenced by the parameterization of its settings and the environment and therefore benefits in particular from the training of the AI computing module during its operation in the specific operating environment.

The design of a corresponding vibronic point level measuring device can, for example, be such that it has a mechanical oscillation system for detecting a medium. An actuator or, in other words, a drive can be used to excite the mechanical oscillation system. The point level measuring device can have an acceleration sensor to detect vibrations of the mechanical vibration system. The actuator or drive can be mechanically coupled to the mechanical oscillation system. The mechanical oscillating system can have oscillating elements, and the point level measuring device can be configured so that the oscillating elements can interact with the medium in order to change the frequency and/or amplitude and/or damping of the mechanical oscillating system by interacting with the medium. The acceleration sensor can be mechanically coupled to the oscillating system, in particular to a diaphragm and/or the actuator or drive of the oscillating system, in order to detect oscillations of the mechanical oscillating system. Measurement signals, in particular electrical measurement signals generated by the acceleration sensor, can be provided to the computing device in order to generate measurement values of a process variable to be detected by the field device, whereby the measurement values can be dependent on the interaction of the mechanical vibration system with the medium. Alternatively or additionally, a voltage on the actuator, in particular a piezoelectric actuator, can also be used as a measurement signal, which can be detected by the voltage pick-up from the actuator.

In particular, measurement signals from the acceleration sensor and the actuator can be recorded. Both measurement signals can be provided to the computing device together and/or in parallel in order to determine the measured value. In this way, a further improvement of the measurement can be provided.

Furthermore, not only current measurement signals can be evaluated to determine the measured value. It is also possible to use a history of the measurement signal to determine the measured value. The history of the measurement signal can be a recording of previous measurement signals. Furthermore, such a history of measurement signals and/or measurement values can also be used as a further basis for training the AI calculation module.

A second aspect of the present disclosure relates to a method for training an AI computing module based on artificial intelligence on a field device for detecting a measured process variable, which is configured in particular as a level measuring device for detecting a level of a medium, wherein the field device has a sensor arrangement which is configured to detect a measurement signal correlating with a measured process variable, and wherein the field device has a computing arrangement which is configured to determine a measured value of the measured process variable based on the measurement signal, wherein the computing arrangement has a deterministic computing module and the AI computing module, wherein the AI computing module is trained during operation of the field device.

A third aspect of the present disclosure relates to a method for operating a field device for detecting a process parameter, which is configured in particular as a level measuring device for detecting a level of a medium, wherein the field device has a sensor arrangement which is configured to detect a measurement signal correlating with a process parameter, and the field device has a computing arrangement which is configured to determine a measured value of the process parameter based on the measurement signal, wherein the computing arrangement has a deterministic computing module and a computing module based on artificial intelligence, the method comprising:
training the AI computing module according to the method according to the second aspect of the invention,
determine that a switch-on criterion based on training is fulfilled, and
execution of an AI-based computing operation of the AI computing module.

The method according to the second or third aspect of the present disclosure can in particular be carried out or be executable on the field device described herein according to the first aspect of the present disclosure.

The method according to the second or third aspect of the present disclosure may further comprise, for example, any one or more of the following steps:
execution of a training mode in parallel with a deterministic computing mode using the deterministic computing module, whereby in particular training data is collected during the training mode and/or the AI computing module is trained with the training data,
termination of the deterministic computing mode, in particular during or after execution of the AI-based computing mode,
execution of the deterministic computing mode and the AI-based computing mode (temporally) in parallel,
determination of the measured value based on a combination of the deterministic computing mode and the AI-based computing mode executed in parallel,
validation of the AI calculation module at least on the basis of measured values determined by the deterministic calculation module, and
re-training of the AI calculation module if at least one parameter influencing the detection of the process parameter changes.

A fourth aspect of the present disclosure relates to a computer program product comprising instructions which, when the program is executed by a computer, cause the computer to perform the method according to the second aspect of the present disclosure or the third aspect of the invention.

The computer program product according to the fourth aspect of the present disclosure may in particular be executed and/or executable and/or stored on the field device described herein according to the first aspect of the invention. The computer program product may in each case be a computer program arrangement or a software arrangement, comprising at least one computer program or at least one computer program code, as such or a product, such as a data memory on which such a computer program arrangement or at least one computer program is stored.

A fifth aspect of the present disclosure relates to training data for training an AI computing module based on artificial intelligence on a field device for detecting a process variable, which is configured in particular as a level measuring device for detecting a level of a medium, wherein the field device has a sensor arrangement which is configured to detect a measurement signal correlating with a process parameter, and wherein the field device has a computing arrangement which is configured to determine a measured value of the process parameter based on the measurement signal, wherein the computing arrangement has a deterministic computing module and the AI computing module, wherein the training data has been collected during operation of the field device.

The training data according to the fifth aspect of the present disclosure may in particular be used on and/or collected by the field device described herein according to the first aspect of the invention. The training data may in particular be configured for training the AI computing module of the field device. In particular, the device may comprise a nature of the training data such that it can be used for training the AI computing module. This nature can be specified by collecting the training data during operation of the field device. It is also possible to change the nature of the collected training data in order to make it usable for training. The nature can, for example, be predetermined by formatting and/or type or kind of training data. It can be advantageous to specify a certain nature of the training data, for example a certain format, such as data format or formatting of the content of the training data as such, in order to optimize the training of the AI computing module.

Features, elements, functions, and/or advantages of the field device described herein may also be applied to the methods described herein, the computer program product and the training data, and vice versa, and in any combination with each other.

In the following, embodiments of the present disclosure are described with reference to the attached figures.

### BRIEF DESCRIPTION OF THE DRAWINGS

FIG. 1 schematically shows a block diagram of a field device according to an embodiment example.

FIG. 2 schematically shows a flow chart illustrating the steps of a method for operating a field device according to an embodiment example.

FIG. 3 schematically shows another flow chart for further illustration of the method from FIG. 2 according to an embodiment example.

FIG. 4 schematically shows a further flow chart for further illustration of the method from FIG. 2 according to a further embodiment example.

FIG. 5 schematically shows a further flow chart for further illustration of the method from FIG. 2 according to a still further embodiment example.

Similar, similarly acting, identical, or identically acting elements in the figures may be provided with similar or identical reference signs.

### DETAILED DESCRIPTION OF EMBODIMENTS

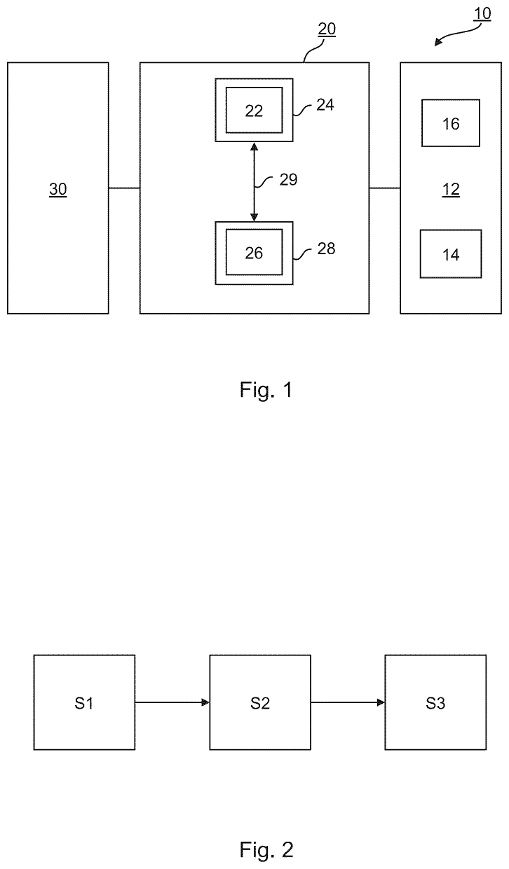

FIG. 1 schematically shows a block diagram of a field device 10 according to an embodiment example. The field device 10 of FIG. 1 is exemplarily designed as a level measuring device 10. Alternatively, the field device 10 can be a pressure measuring device, a temperature measuring device, a flow velocity measuring device, a flow rate measuring device, or any other field device 10.

The field device 10 is configured to detect a measured process parameter, in particular the level of a medium in a container not shown. In particular, the field device 10 can be configured as a vibronic limit level measuring device, in which it is only determined whether a predefined fill level or limit level is reached by the medium in the container.

The field device 10 has a sensor arrangement 12. The sensor arrangement 12 has at least one sensor 14, which in this example is designed as an acceleration sensor of the vibronic level meter. The acceleration sensor measures an acceleration, which is recorded here as a measurement signal by the sensor arrangement 12. In addition, the sensor arrangement 12 has an actuator 16, in particular a piezoelectric actuator, whose voltage consumption can be recorded as the measurement signal correlating with the process parameter.

In principle, however, the field device 10 may also have only one sensor 14 or one unit that detects a measurement signal, in particular according to one measurement principle. The method explained in more detail later can also or at least only evaluate one such measurement signal, which can be based on just one measurement principle or measurement method, or alternatively several measurement signals, and in particular detect or determine the process parameter from them.

The field device 10 also has a computing arrangement 20. The computing arrangement 20 can be configured to control the sensor arrangement 12. In particular, the computing arrangement 20 is configured to process the measurement signal detected by the sensor arrangement 12 and/or to determine a measured value of the process parameter.

The computing arrangement 20 has a deterministic computing module 22. The computing arrangement 20 further comprises an AI computing module 26 based on artificial intelligence (AI). The AI computing module 26 may comprise at least one artificial neural network. The deterministic computing module 22 may be executable by a first computing unit 24 of the computing arrangement 20, in particular in the form of a computer program, and/or may be stored in the first computing unit 24, in particular in a data memory contained therein. The deterministic calculation module 22 can be executed by a processor of the first arithmetic unit 24, which is not shown. The AI computing module 26 may be executable, in particular in the form of a computer program, by a second computing unit 28 of the computing arrangement 20 and/or may be stored in the second computing unit 28, in particular in a data memory contained therein. The AI computing module 26 can be executed by a processor of the second computing unit 28, which is not shown.

Accordingly, the first and the second arithmetic units 24, 28 can be separate, and/or separately designed, and/or arranged in separate housings. Alternatively, the two arithmetic units 24, 28 may be arranged in a common housing. Alternatively, the deterministic computing module 22 and the AI computing module 26 may be executed by a single processor and/or stored on a common data memory. In particular, the first and the second arithmetic units 24, 28 may have common memory areas or separate memory areas in a data memory of the field device 10, which is not shown.

The two arithmetic modules 22, 26 and/or the two arithmetic units 24, 28 are connected to each other via a communication link 29. Accordingly, it is possible to exchange communication, in particular data, between the two computing modules 22, 26 and/or the two arithmetic units 24, 28. This can be useful, for example, for training the AI computing module 26, validating measured values of the two computing modules 22, 26, and many other applications, as will be explained in more detail below.

The deterministic calculation module 22 is designed for a deterministic calculation operation 23, which can comprise one or more deterministic calculation operations. Such arithmetic operations can, for example, be associated with processing of the acquired measurement signals, in particular determination of the measured value of the process parameter based on the measurement signal, scaling to determine the measured value based on the measurement signal, unit conversion to determine the measured value based on the measurement signal and/or monitoring of the functionality of the field device 10.

The AI computing module 26 is configured to perform an AI computing operation 27, which may comprise one or more non-deterministic, probability-based, and/or classification-based computing operations. Such computing operations may be related to the features already explained with respect to the computing operations of the deterministic computing module 22. In addition, the arithmetic operations may be associated with detecting aging of at least a part of the field device 10, detecting drift of the sensor arrangement 12, detecting contamination of at least a part of the sensor arrangement 12, detecting a signal quality of the measurement signal, detecting a signal strength of the measurement signal, detecting at least one interference influence on the measurement signal, and/or detecting electromagnetic interference of at least a part of the field device 10.

The first arithmetic unit 24, the second arithmetic unit 28, and/or both arithmetic units 24, 28, in particular the entire arithmetic arrangement 20, and at least the sensor 14 can otherwise form an integrated system, in particular be connected to one another, be arranged adjacent to one another, and/or be arranged in a common housing. Such an integrated system or any arithmetic unit 24, 28 or the arithmetic arrangement 20 can be arranged close to or directly on a corresponding piezo element of the actuator 16. Close can mean in particular that there is only one element between the respective components, in particular only one circuit board. This allows a compact design of the field device 10 to be achieved.

Finally, the field device 10 can also comprise an output unit 30. The output unit 30 can be a display, for example. The output unit 30 can output, in particular display, the determined measured value of the process parameter and/or the process parameter.

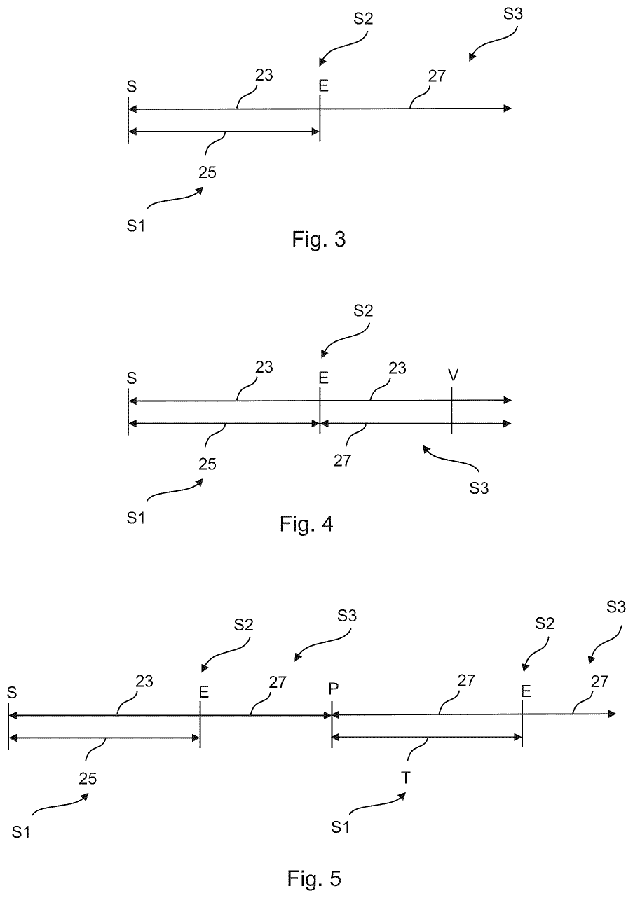

FIG. 2 schematically shows a flow chart illustrating steps S1, S2, S3 of a method for operating the field device 10 of FIG. 1. In a first step S1, the AI computing module 26 is trained. The first step S1 is also referred to herein as training operation 25 (see FIGS. 3 to 5). In a second step S2, a check or determination is made as to whether a switch-on criterion based on the training is fulfilled. In a third step S3, the AI-based computing operation 27 of the AI computing module 26 described above is executed.

Steps S1 to S3 are illustrated in an exemplary chronological order in the schematic representation of the method according to various embodiments of FIGS. 3 to 5.

FIG. 3 shows a start time S for the start of operation of the field device 10. From this start time S, the operation of the field device 10 begins, which includes the deterministic calculation mode 23, by means of which the calculation arrangement 20 can determine the measured value of the process parameter based on the measurement signals of the sensor arrangement 12 and thus record the process parameter. Training mode 25 is executed at the same time.

From a switch-on time E in the runtime or operating time of the operation of the field device 10, which occurs when the switch-on criterion according to the second step S2 is fulfilled, the AI computing module 26 is sufficiently or fully trained to now be used. The switch-on criterion can, for example, be at least one of a predefined match of at least one determined measured value of the process parameter from the deterministic computing module 22 and at least one determined measured value of the process parameter from the AI computing module 26, a predefined operating time of the field device 10, and a predefined data quantity and/or data quality of the training data. Consequently, the deterministic computing mode 23 is terminated at the switch-on time E and the AI computing mode 27 is “switched on” or executed, which corresponds to the third step S3.

FIG. 4 shows a modification of the method of FIG. 3 in that the deterministic computing mode 23 is not terminated at the switch-on time E, but continues to run in parallel with the AI computing mode 27.

The measured value after the switch-on time E can be determined on the basis of a combination of the deterministic computing mode 24 and the AI-based computing mode 27 executed in parallel.

It is also possible to validate the AI calculation module 26 at least on the basis of measured values determined by the deterministic calculation module 22. By way of example, a validation time V is shown here at which the validation can be carried out. Of course, several validation times V can be specified or present, and ongoing or continuous validation is also possible.

FIG. 5 shows an extension of the method in FIG. 3 in that a parameterization of the field device 10 changes at a parameter change time P. The parameterization can affect both the field device 10 itself, in particular its settings, and the environment, in particular ambient conditions outside or inside the container, for example a density of the medium. As a result, the previous AI calculation mode 27 is terminated at the parameter change time P and the deterministic calculation mode 23 is used again. At the same time, a new training mode 25 is started, which teaches a new AI computing module 26 or updates the existing AI computing module 26 by training it again, which is then used again at switch-on time E to execute the new AI computing mode 27. The field device 10 can therefore react particularly flexibly to parameter changes, in particular to ensure high measurement accuracy and/or low susceptibility to errors.

In addition, it should be noted that “comprising” and “having” do not exclude other features or steps and the indefinite articles “a” or “an” do not exclude a plurality. It should also be noted that features or steps described with reference to one of the above embodiments may also be used in combination with other features or steps of other embodiments described above. Reference signs in the claims are not to be regarded as limitations.

1. A field device for detecting a process parameter and being configured as a level measuring device for detecting a level of a medium, the field device comprising:
a sensor arrangement configured to detect a measurement signal correlating with a process parameter; and
a computing arrangement configured to determine a measured value of the process parameter based on the measurement signal, the computing arrangement having a deterministic computing module and an artificial intelligence (AI) computing module based on AI,
wherein the field device is further configured to train the AI computing module during operation thereof.

2. The field device according to claim 1, wherein training data of the AI computing module is based at least on measurement signals of the sensor arrangement.

3. The field device according to claim 1, wherein the field device is further configured to execute a training operation in parallel to a deterministic computing operation using the deterministic computing module, in which training data is collected and the AI computing module is trained with the training data.

4. The field device according to claim 3, wherein the field device is further configured to execute an AI-based computing operation of the AI computing module after a switch-on criterion based on the training operation has been met.

5. The field device according to claim 4, wherein the field device is further configured such that the execution of the AI-based computing operation terminates the deterministic computing operation, and/or the deterministic computing operation and the AI-based computing operation are executed in parallel.

6. The field device according to claim 5, wherein the field device is further configured to determine the measured value on the basis of a combination of the deterministic computing operation with the AI-based computing operation executed in parallel thereto.

7. The field device according to claim 1, wherein the field device is further configured so that the AI computing module is validated at least on the basis of determined measured values of the deterministic computing module.

8. The field device according to claim 1, wherein the field device is further configured to retrain the AI computing module if at least one parameter influencing detection of the process measured variable changes.

9. The field device according to claim 1, wherein the deterministic computing module is implemented in a first computing unit and the AI computing module is implemented in a second computing unit.

10. The field device according to claim 1, wherein the sensor arrangement comprises a sensor in a form of an acceleration sensor and/or an actuator of the field device.

11. The field device according to claim 10, wherein the field device is further configured as a vibronic point level measuring device.

12. A method for training an artificial intelligence (AI) computing module based on AI on a field device for detecting a process parameter, the field device being configured as a level measuring device for detecting a level of a medium, the field device comprising a sensor arrangement configured to detect a measurement signal correlating with a process parameter, and the field device comprising a computing arrangement configured to determine a measured value of the process parameter based on the measurement signal, wherein the computing arrangement comprises a deterministic computing module and the AI computing module, the method comprising training the AI computing module during operation of the field device.

13. A method for operating a field device for detecting a process parameter, the field device being configured as a level measuring device for detecting a filling level of a medium, the field device comprising a sensor arrangement configured to detect a measurement signal correlating with a process parameter, and the field device comprising a computing arrangement configured to determine a measured value of the process parameter based on the measurement signal, the computing arrangement comprising a deterministic computing module and an artificial intelligence (AI) computing module based on AI, the method comprising:
training the AI computing module according to the method of claim 12;
determining that a switch-on criterion based on training is fulfilled; and
executing an AI-based computing operation of the AI computing module.

14. A nontransitory computer-readable medium having stored thereon instructions that, when executed by a computer, cause the computer to perform the method according to claim 12.

15. A nontransitory computer-readable medium having stored thereon instructions that, when executed by a computer, cause the computer to perform the method according to claim 13.

16. Training data for training an artificial intelligence (AI) computing module based on AI on a field device for detecting a process parameter, the field device being configured as a level measuring device for detecting a level of a medium, the field device comprising a sensor arrangement configured to detect a measurement signal correlating with a process parameter, and the field device comprising a computing arrangement configured to determine a measured value of the process parameter based on the measurement signal, wherein the computing arrangement comprises a deterministic calculation module and the AI calculation module, wherein the training data has been collected during operation of the field device.
